(19) United States
(12) Patent Application Publication
(10) Pub. No.: US 2006/0137889 A1
(43) Pub. Date: Jun. 29, 2006

(54) Hammer mechanism for power tool

(76) Inventor: Andreas Hanke, Bad Camberg (DE)

Correspondence Address: Michael P. Leary;Sr. Group Patent Counsel, Black & Decker Corporation, Mail Stop TW199, 701 E. Joppa Rd, Towson, MD, 21286, US

(21) Appl. No.: 11/314,523

(22) Filed: Dec. 21, 2005

(30) Foreign Application Priority Data
Dec. 23, 2004 (GB) GB 0428215.8
Aug. 11, 2005 (GB) GB 0516506.3

(51) Int. Cl. B25D 9/00

(52) U.S. Cl. 173/114; 173/217

(57) ABSTRACT

A rotary hammer includes a motor with an output shaft and pinion. The pinion drives a gear which is mounted to a drive shaft. A crank plate having an eccentrically disposed crank pin is mounted to the top of the drive shaft. A crank arm is pivotally connected to the crank pin and to the underside of a hollow piston. Hollow piston defines an internal bore, and the hollow piston is slidably mounted on two guide rods. Rotation of the drive shaft and turns the crank plate, and the eccentric motion of crank pin drives the crank arm. Due to the pivotal connection between the crank arm and the hollow piston 44, the hollow piston is caused to reciprocate back and forth along the guide rods.

### FIELD OF THE INVENTION

The present invention relates to a hammer mechanism for a power tool, and to a power tool incorporating such a mechanism. The invention relates particularly, but not exclusively to a hammer mechanism for a hammer drill having a hammer mode, a rotary mode, and a combined hammer and rotary mode, and to a power tool incorporating such a mechanism.

### BACKGROUND OF THE INVENTION

Hammer drills are power tools, which can generally operate in one of three modes of operation. Generally, a hammer drill will have a tool bit, which can be operated in a hammering mode, a drilling mode and a combined hammering and drilling mode.

European patent application EP0775556 describes a drive mechanism for such a hammer drill. This mechanism comprises a hollow piston in which a ram member is slidably disposed. The hollow piston is slidably mounted on a pair of guide rods and connected at the rear of the hollow piston to a wobble plate such that the hollow piston can be reciprocated back and forth along the guide rods by means of the wobble plate when a motor of the drill is actuated. The reciprocation of the hollow piston causes the ram member to move with the piston and cause compression of the air in the piston, which in turn causes the ram to impart impacts on an end of the tool bit, thus causing the hammering action of the power tool. The tool bit is also mounted in a spindle which is caused to rotate by the electric motor of the tool for the drilling mode.

EP0775556 suffers from the drawback that as the reciprocation of the hollow piston is driven by a wobble plate mounted at the rear of the hollow piston, the mechanism for causing this reciprocation is relatively large in the direction of reciprocating motion, and it is difficult to make the mechanism of compact construction in that direction.

DE19856638 discloses a hammer drill in which a piston is reciprocally driven by means of a wobble plate connected to a side of the piston, in order to impart impacts to a drill bit. Although this arrangement can be made more compactly than the arrangement of EP0775556 in the direction of reciprocating motion of the piston, the provision of a wobble plate on one side of the piston prevents the drill from being made compact in a direction transverse to the direction of reciprocating motion.

Preferred embodiments of the present invention seek to overcome the above disadvantages of the prior art.

### BRIEF SUMMARY OF THE INVENTION

According to an aspect of the present invention, there is provided a hammer mechanism for a power tool having a housing and a motor disposed in the housing and having an output shaft for actuating a tool bit of the tool, the hammer mechanism comprising:—

a plurality of guide rods;

at least one hollow piston adapted to be mounted to a plurality of said guide rods and adapted to be caused to execute reciprocating movement along said guide rods by means of engagement of at least one drive member with a side of the hollow piston; and

at least one ram member slidably mounted in a said hollow piston and adapted to impart impacts to a tool bit of the tool as a result of reciprocating movement of said hollow piston.

By providing at least one hollow member adapted to execute reciprocating movement on said guide rods by means of engagement of at least one drive member with a side of the hollow member, the guide rods provide the advantage of enabling the mechanism to be of lightweight and strong construction, while the engagement of the drive member with the side of the hollow member enables the mechanism to be of compact construction in the direction of reciprocating movement.

In a preferred embodiment, at least one said hollow piston is slidably mounted on two guide rods having longitudinal axes substantially parallel to each other.

At least one said drive member may engage at least one said hollow piston at a point between the respective guide rods.

In a preferred embodiment, at least one said drive member engages at least one hollow piston on an underside of the hollow piston.

By providing a guide member that engages the hollow piston on its underside, this provides the advantage of reducing the length and width of the hammer mechanism. It is ergonomically preferable to decrease the length and width of the tool rather than the height of the tool, to enable easier handling of the tool.

The mechanism may further comprise at least one crank member adapted to engage a side of said hollow piston and to rotate about an axis to cause reciprocating movement of said hollow piston.

This provides the advantage of enabling the mechanism to be of more compact construction than a mechanism incorporating one or more wobble plates.

The mechanism may further comprise at least one crank plate adapted to be rotated by means of said output shaft, and a respective crank pin eccentrically mounted on at least one said crank plate and pivotally connected to a respective said crank member such that rotation of the crank plate causes reciprocation of a said hollow piston along a plurality of said guide rods.

The mechanism may further comprise rotation means for rotating a tool bit of the tool by means of said motor.

The rotation means may comprise a drive shaft extending transversely to an axis of rotation of the tool bit.

This provides the advantage of a more compact construction of a power tool incorporating such a mechanism.

According to another aspect of the present invention, there is provided a power tool comprising a housing, a motor disposed in the housing and having an output shaft for actuating a tool bit of the tool, and a hammer mechanism as defined above.

In a preferred embodiment, the power tool is a hammer drill.

### BRIEF DESCRIPTION OF THE DRAWINGS

A preferred embodiment of the present invention will now be described, by way of example only and not in any limitative sense, with reference to the accompanying drawings in which:—

FIG. 1 is a partial cut-away side view of a hammer drill embodying the present invention;

FIG. 2 is a perspective view of a hammer mechanism of the hammer drill of FIG. 1;

FIG. 3 is a rear view of the hammer drill of FIG. 1;

FIG. 4 is a cross sectional view of the hammer drill of FIG. 1 taken along the line A-A of FIG. 3;

FIG. 5 is a cross sectional view from the top of the hollow piston and guide rods of the present invention taken along the line B-B of FIG. 4; and

FIG. 6 is an exploded top view of the hammer drill of FIG. 1.

### DETAILED DESCRIPTION OF THE INVENTION

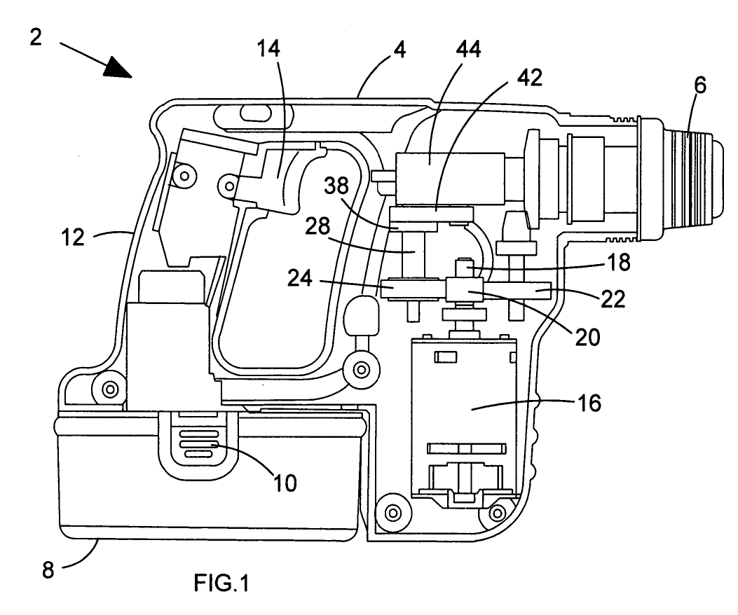

Referring to FIG. 1, a hammer drill shown generally by 2 comprises a housing 4 formed from two clam shell halves of durable plastics material, as will be understood by persons skilled in the art. Extending from a forward end of housing 4 is a chuck 6 or similar device for gripping a tool bit. A rechargeable battery pack 8 is removably attached to the bottom of the housing, and can be removed from the housing 4 by depressing clips 10 to release the battery pack for recharging. The housing 4 comprises a handle portion 12 having a trigger 14 for activation of the hammer drill by means of an electric motor 16 disposed in the housing. An output shaft 18 extends from the electric motor 16, the output shaft 18 having a pinion 20 formed thereon. The pinion 20 has a plurality of gear teeth formed on its outer surface (not shown).

Referring to FIGS. 1, 2 and 4, pinion 20 of output shaft 18 intermeshes with a first gear 22 and a second gear 24. As a result, when output shaft 18 is activated and rotates, gears 22 and 24 will also rotate. A first drive shaft 26 is fixed to gear 22 such that first drive shaft 26 rotates with first gear 22, and second drive shaft 28 is fixed to second gear 24 such that second drive shaft 28 rotates with second gear 24.

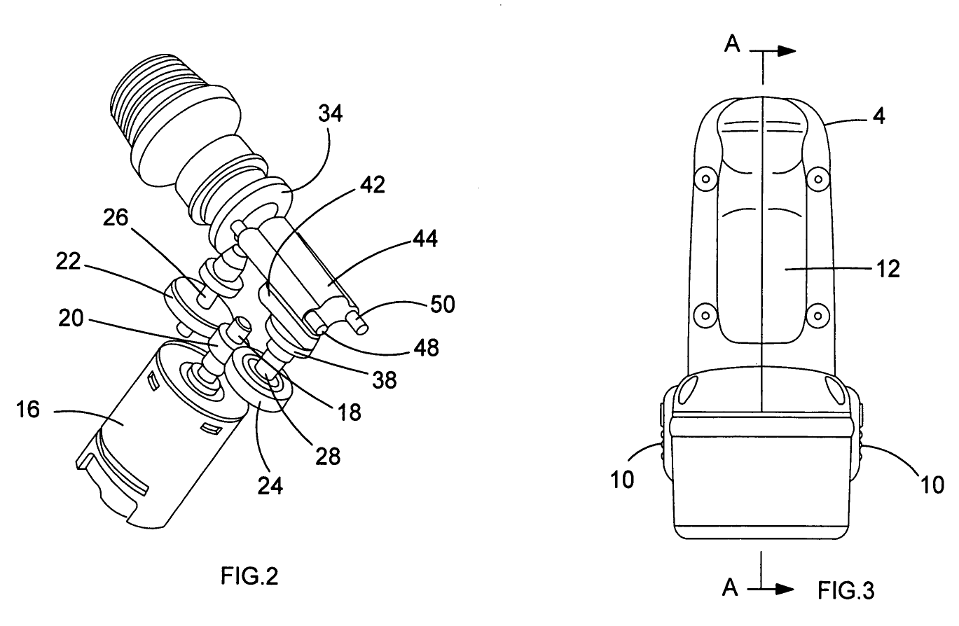

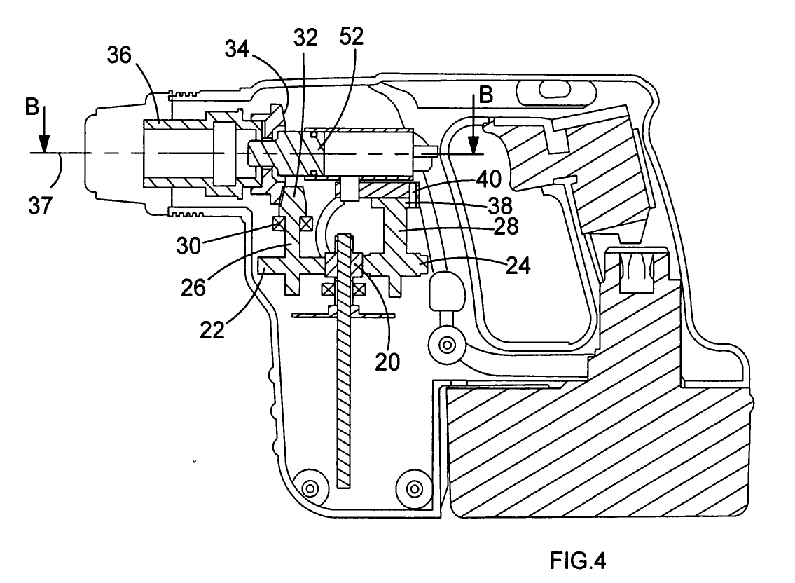

With reference to FIGS. 2 and 4, the operation of the rotary mode of hammer drill 2 will now be described.

When motor 16 is actuated, drive shaft 18 rotates causing pinion 20 to rotate. Pinion 20 drives first gear 22 and first drive shaft 26 which is supported by bearings 30. A first bevel gear 32 is mounted at the upper end of first drive shaft 26 such that first bevel gear 32 rotates with drive shaft 26. A second bevel gear 34 is mounted to a spindle 36 for receiving a drill bit (not shown), the spindle 36 being rotatably mounted in the housing about axis 37. The bevel gears 32, 34 mesh with each other such that rotation of first bevel gear 32 causes second bevel gear 34 to rotate about axis 37. This provides the drilling action.

Referring to FIGS. 2, 4 and 5 the hammer mode of the hammer drill 2 will be described.

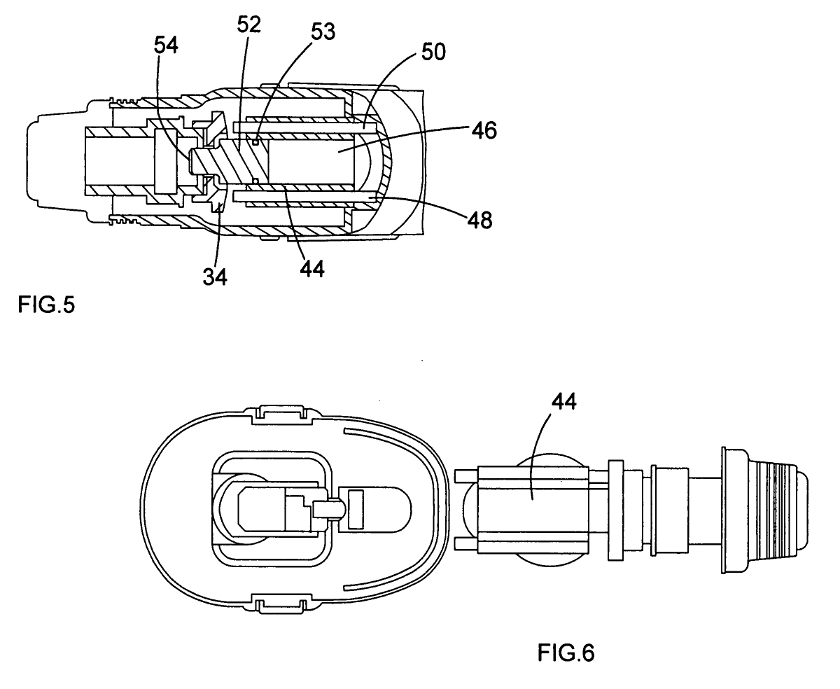

When the motor 16 is actuated by means of trigger switch 14, the output shaft 18 of the motor rotates along with pinion 20. Pinion 20 has gear teeth (not shown) which are intermeshed with the gear teeth (not shown) of second gear 24. As a result, second gear 24 which is mounted to drive shaft 28 rotates. A crank plate 38 having an eccentrically disposed crank pin 40 (FIG. 4) is mounted to the top of drive shaft 28. A crank arm 42 is pivotally connected to the crank pin 40 and to the underside of a hollow piston 44. Hollow piston 44 comprises an internal bore 46 (FIG. 5), and the hollow piston 44 is slidably mounted to guide rods 48, 50. Consequently, on rotation of second drive shaft 28 and crank plate 38, the eccentric motion of crank pin 40 drives crank arm 42, and due to the pivotal connection between crank arm 42 and the underside of hollow piston 44, the hollow piston is caused to reciprocate back and forth along guide rods 48, 50.

A ram member 52 is slidably disposed in the bore 46 of hollow piston 44, and an o-ring 53 (FIG. 5) is arranged between the ram member 52 and the internal surface of the piston 44. The ram member 52 forms a seal with the interior of the hollow piston 44 such that on reciprocation of hollow piston 44 the ram member 52 oscillates relative to the piston 44 under an air spring affect. The ram member comprises a forward end 54 which passes into spindle 36. As the ram member 52 oscillates, the forward end 54 of ram member 52 strikes the rear portion of a tool bit (not shown) to provide a hammer action of the drill.

A mode change mechanism (not shown) allows the user to select one of the hammer mode, the rotary mode, or the combined hammer and rotary mode. For example, the hammer mode is selected by disengagement of the gear 22 from the pinion 20. The rotary mode is selected by disengagement of the gear 24 from the pinion 20. Whereas, the combined hammer and rotary mode is selected when both of the gears 22 or 24 remain engaged with the pinion 20.

The provision of hollow piston 44 slidably mounted to guide rods 48, 50, together with crank pin 40 engaging the underside of the hollow piston 44 enables the drill to be of considerably more compact construction than the prior art.

It will be appreciated by persons skilled in the art that the above embodiment has been described by way of example only, and not in any limitative sense, and that various alterations and modifications are possible without departure from the scope of the invention as defined by the appended claims.

1. A hammer mechanism for a power tool having a housing and a motor disposed in the housing and having an output shaft for actuating a tool bit of the tool, the hammer mechanism comprising:—
a drive member;
a plurality of guide rods;
a hollow piston slidably mounted on said plurality of guide rods and engaged by the drive member to be caused to execute reciprocating movement along said guide rods; and
a ram member slidably mounted in said hollow piston and adapted to impart impacts to the tool bit of the tool as a result of the reciprocating movement of said hollow piston.

2. A hammer mechanism according to claim 1, wherein said plurality of guide rods includes a first guide rod defining a first longitudinal axis and a second guide rod defining a second longitudinal axis and wherein the first longitudinal axis is substantially parallel to the second longitudinal axis.

3. A hammer mechanism according to claim 2, wherein said drive member engages said hollow piston at a point between the first guide rod and the second guide rod.

4. A hammer mechanism according to claim 2, wherein said drive member engages said hollow piston on an underside of the hollow piston.

5. A hammer mechanism according to claim 1, further comprising a crank member engaged to a side of said hollow piston and rotatable about an axis to cause reciprocating movement of said hollow piston.

6. A hammer mechanism according to claim 5, further comprising a crank plate rotatably connected to said output shaft, and a crank pin eccentrically mounted on said crank plate and pivotally connected to said crank member such that rotation of the crank plate causes reciprocation of said hollow piston.

7. A hammer mechanism according to claim 1, further comprising a rotary drive transmission for rotating the tool bit of the tool around an axis of rotation by means of said motor.

8. A hammer mechanism according to claim 7, wherein the rotary drive transmission includes a drive shaft extending transversely to said axis of rotation of the tool bit.

9. A power tool comprising:
a tool bit;
a housing,
a motor disposed in the housing and having an output shaft;
a hammer mechanism including:
a reciprocating drive transmission;
a plurality of guide rods;
a hollow piston slidably mounted on said plurality of guide rods and drivable by the reciprocating drive transmission to be caused to execute reciprocating movement along said guide rods; and
a ram member slidably mounted in said hollow piston and adapted to impart impacts to the tool bit as a result of the reciprocating movement of said hollow piston.

10. A power tool according to claim 9, wherein the power tool is a hammer drill.

11. A rotary hammer comprising:
a housing;
a motor mounted in the housing and including an output shaft;
an output spindle rotatably supported in the housing;
a first guide rod mounted in the housing and defining a first axis;
a second guide rod mounted in the housing and defining a second axis, the second axis parallel to the first axis;
a hollow piston slidably mounted on the first guide rod and the second guide rod in the housing rearward of the output spindle, the hollow piston defining an internal bore and a third axis parallel to the first axis;
a ram slidably mounted in the internal bore of the hollow piston;
a first transmission connected between the motor output shaft and the output spindle for driving the output spindle in rotation; and
a second transmission connected between the motor output shaft and the hollow piston for converting rotation of the motor output shaft into reciprocating motion of the hollow piston.
